(19) United States
(12) Patent Application Publication
(10) Pub. No.: US 2014/0006343 A1
(43) Pub. Date: Jan. 2, 2014

(54) Methods and Systems for Generating a List of Recent Contacts

(71) Applicant: Sean Edward Allison, Durham, NC (US)

(72) Inventor: Sean Edward Allison, Durham, NC (US)

(73) Assignee: ORGSPAN, INC., Durham, NC (US)

(21) Appl. No.: 13/933,084

(22) Filed: Jul. 1, 2013

Related U.S. Application Data
(60) Provisional application No. 61/666,311, filed on Jun. 29, 2012.

(51) Int. Cl. G06F 17/30

(52) U.S. Cl. CPC G06F 17/30345
USPC 707/609

(57) ABSTRACT

Methods and systems are described for generating a list of recent contacts are described. A method for generating a list of recent contacts includes generating a directory comprising a plurality of contacts, receiving a communication notification associated with a communication type and one of the plurality of contacts, and updating a list of recent communications with the contact and the communication type.

### RELATED APPLICATIONS

This application claims priority from U.S. provisional application Ser. No. 61/666,311 entitled “Methods and Systems for Generating a List of Recent Contacts” filed 29 Jun. 2012.

### FIELD

This invention relates generally to enterprise software and in particular to methods and systems for generating a list of recent contacts.

### BACKGROUND

Modern businesses and organizations can include hundreds or thousands of members spread across many locations. Each member may be contacted through a variety of communication types, such as email, phone calls, or text messaging. Typical communication systems, however, are insulated and do not share information across applications or platforms.

Thus there is a need for methods and systems to arrange and present communication information.

### SUMMARY

Methods and systems are described for generating a list of recent contacts. In one embodiment, a method for generating a list of recent contacts comprises generating a directory comprising a plurality of contacts, receiving a communication notification associated with a communication type and a contact, and updating a list of recent communications with the contact and the communication type.

In another embodiment, executable instructions are stored on a non-transitory computer-readable storage medium, the executable instructions that, when executed by a processor cause the processor to perform operations comprising generating a list of recently contacted organization members across various types of communication. The list of recently contacted organization members may include icons representing what how each member was contacted.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate embodiments of the present invention and, together with the description, serve to explain the principles of the invention and to enable a person skilled in the pertinent art to make and use the invention.

FIGS. 1-3 are flow charts illustrating embodiments of methods for generating a list of recent contacts.

FIG. 4 is a flow chart illustrating an embodiment of a method for generating a list of recent actions.

FIG. 5 is a block diagram illustrating an embodiment of a system for generating a list of recent contacts.

FIGS. 6-7 are screenshots illustrating multiple views of embodiments for generating a list of recent contacts.

### DETAILED DESCRIPTION

Methods and systems are described for generating a list of recent contacts. During the span of a typical day, a user may utilize a variety of communication types, such as telephone, email, and text message, on a variety of different communication platforms, such as a computer or a smart phone, to contact other people. Embodiments may advantageously generate a list of recent contacts across a variety of communication types, such as telephone, email, and chat, and across different platforms.

In one exemplary embodiment, a user accesses a directory comprising a plurality of contacts in a graphical user interface, such as a web browser or native mobile device application. The directory may comprise an hierarchical organization directory, comprising a plurality of organization members. Contact information for some or all of the contacts may be stored in the directory. Such contact information may comprise one or more types of communications for each contact, such as phone numbers, email addresses, and instant message handles. The contact information may be displayed in the form of communication links, or shortcuts, for launching communication applications associated with each type of communication information, such clicking on a contact's email address shown in the directory may cause an email application to be launched, while selecting a contact's phone number may cause a telephone application to be launched.

In the example, a communication notification may be generated when a communication shortcut is clicked, selected, or otherwise activated. The communication notification may comprise the type of communication associated with the communication shortcut (e.g. email, telephone, voice chat, instant message, etc.) and an intended contact (e.g. an intended recipient for an email or an intended contact for a telephone call). As communication notifications are received, a list of recent contacts may be generated and updated. The list of recent contacts may comprise one or more contacts that a user has recently communicated with, as well as an indication of how each contact has been communicated with (i.e. the type(s) of communication used to communicate with a contact), such as an email icon and a telephone icon. The recents list may be sorted according to most recently contacted contact, highest frequency contacted contact, or according to some other method.

Communication notifications may be generated by an organization hierarchy application operating on a mobile device, or on a desktop computer, and received by a server. The server may update a list of recent contact for each organization hierarchy application user, and transmit the list to each user's device.

### Example Methods

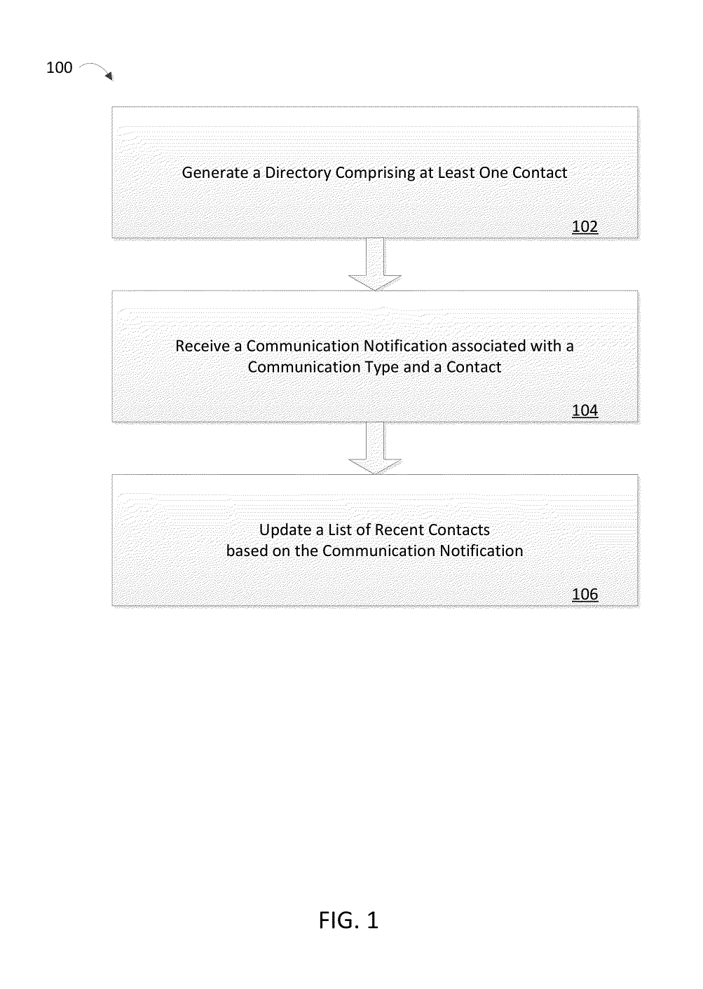

FIGS. 1-4 are flow charts illustrating embodiments of methods for generating a list of recent contacts. Turning to the first drawing, FIG. 1 is a flow chart illustrating a first method 100 for generating a list of recent contacts. In the first step 102, a directory is generated comprising at least one contact. A directory may comprise a collection of one or more items. Each item may be associated with a least one type of communication, such as an email address or phone number.

A contact in a directory may correspond to a person, such as a member of an organization. In one embodiment, a contact in a directory may comprise a name (e.g. first name, last name, nick name, surname) and one or more contact addresses for communicating with the contact. A contact address may comprise an email address, phone number, chat handle, or other type of address associated with a communication medium.

In one embodiment an enhanced organization directory in the form of an organization hierarchy is generated. An organization hierarchy may comprise a plurality of interconnected organization members, including their hierarchical relationships within an organization. An organization hierarchy comprising a plurality of contacts may be generated by reading data from a directory database, such as an Active Directory database. In other embodiments, data may be read from other sources

In step 104, a communication notification is received. A communication notification may comprise a notification that a communication shortcut shown in an directory application, such as an organization hierarchy application, has been activated. The communication notification may be transmitted by the directory application executing on a client device, and received by a remote server. Each one of the one or more notifications may be associated with a communication type and a contact.

In various embodiments one or more servers may receive the plurality of notifications. A server may receive notifications generated by one or more applications operating on remote devices. For example, a server may receive notifications from an iOS iPhone application operating on an iPhone, an Android application operating on an Android smart phone, or a web application operating in a web browser on a desktop computer. In another embodiment, notifications may be received by other devices. For example, an application executing on a communication device may receive one or more communication notifications.

Each one of the one or more notifications may be associated with a communication type. A communication type may be a form of communication utilized by an application user to communicate with one or more contacts. Examples of communication types include, but are not limited to, email, telephone (i.e. voice call), video chat (i.e. video call), text message (i.e. SMS message), tweet, or an instant message.

Additionally, each notification may comprise a contact. A contact may be a person or persons that an application user intends to or actually does communicate with. For example, an intended recipient that the user desires to email. In some embodiments, the intended recipient may comprise a plurality of contacts, such as a team, a group, or an entire organization. In such embodiments, a notification may comprise an identifier associated with each individual recipient in the group of recipients.

A notification may also comprise a user identifier. In order to access a communication shortcut within an application, a user may need to log in to the application. The user identifier may comprise an identifier of the user logged in to the application and/or the user initiating a communication, such as by clicking a communication shortcut. A user identifier may comprise a name, employee id, or other form of identifier. A user identifier may be used to associate multiple notifications with the same user across multiple instances of an application, for example, on different devices and/or on different days.

A notification may be generated based on an intended, partial, and/or completed communication action. In some embodiments, a notification may be generated when a user selects a communication shortcut to launch a communication application, for example, by selecting an email address in a contact profile. Alternatively, in other embodiments, a notification may be generated based only on a completed communication actions. For example, notifications may only be generated after a completed call or a successfully delivered text message. Or, notifications may be generated based on both an intended and/or partial communication action, such as a missed call, a draft email, or an unsent text message, as well as completed communication actions.

Notifications may be generated by a software application executing on a communication device. For example, an iOS version of an organization hierarchy viewer executing on an iPhone may generate a notification. In other embodiments, the software application may comprise an Android application, an iOS iPad application, or a web application. A notification may be generated as a user activates or selects a communication shortcut. For example, when a user clicks or taps on an email address shown in a contact profile, the application generates a notification.

A notification may be transmitted over a network, such as an internal intranet or the internet. A server may receive a notification, for example, in the form of an HTTP POST message. In one embodiment the notifications are formatted according to JavaScript Object Notation (JSON). In another embodiment, the notifications are formatted according to Extensible Markup Language (XML). In other embodiments, the plurality of notifications may be formatted according to a different format. In some scenarios, all notifications are received in the same format. In other scenarios, notifications may be received in different formats.

In step 106 of method d 100, a list of recent contacts is updated based on the communication notification. In one embodiment a server may generate the list of recent contacts. In another embodiment an application operating on a client device, such as a mobile phone or a personal computer, may generate the list of recent contacts. A list of recent contacts may be generated and/or updated for each user and/or contact associated with a communication. For example, when a notification is received comprising a communication type, a contact, and a user identifier, a list of recent contacts is updated for the user associated with the user identifier as well as the contact.

The list of recent contacts may comprise a list of zero, one, or more contacts that have been recently communicated with by a user. In one embodiment, the list of recent contacts comprises a plurality of list entries in the form of contacts.

In one embodiment, each list entry in the list of recent contacts, i.e. each recent contact, comprises a name, an image associated with the contact, and one or more communication icons associated with one or more types of communication (e.g. email, phone, text message). The one or more communication icons may correspond to each communication type a user engaged to communicate with that contact. Some recent contacts may be associated a single communication type. For example, a user may contact their manager only by telephone. In such an example, the manager may appear in the list of recent contacts with only one communication icon, i.e. a telephone icon. Other recent contacts may be associated with a plurality of communication types. For example, a user may contact a team member using email and instant messages. The team member may appear in the list of recent contacts with a communication icon for each communication type used to communicate with that recent contact, e.g. an email icon and a test message icon.

A communication icon may comprise a communication shortcut. For example, an email icon appearing alongside a recent contact name in the list of recent contact names may launch an email application, and a draft email to that contact, when the communication icon is selected or activated by a user.

Other information may be included in the list of recent contacts. Examples of other types of information that may be shown in the list of recent contacts includes a status of a recent contact, the location of a recent contact, or the date of the most recent communication with a contact.

The list of recent contacts may be updated based on information apart from communication notifications. For example, the appearance of a recent contact in a list of recent contacts may be grayed-out or dulled when that contact has an “away” status, or is currently scheduled as being in a meeting. As another example, a contact may sign out of a Communication type, such as ICQ, AIM, or Gtalk, and an associated icon may then by grayed out and/or deactivated.

A server may detect that a recent contact is currently in the same building, or on the same floor, as a user viewing a list of recent contacts. The appearance of that recent contact in the list of recent contacts may be emphasized, for example by blinking or bouncing the recent contact name, to indicate that the recent contact may be readily available for a face-to-face conversation.

A picture associated with a recent contact may be updated when that recent contact changes or updates their own picture. In one embodiment, an application detects a change associated with a user, and generates a notification comprising the change and a user identifier. A server may use this information to update entries associated with that user on one or more devices. For example, when a user uploads a new picture on a local instance of an application, the application may send a notification of this picture update to a server. The server may update a database entry associated with that user with the new picture. A list of recent contacts may comprise one or more pointers to database records for each recent contact. When the database is remotely updated with the new picture, each list of recent contacts showing that user as a recent contact may be automatically updated.

The list of recent contacts may be ranked, or weighted. In one embodiment, a ranking algorithm, or weighting algorithm, is used to rank each communication. Some communication types, such as a telephone call, may be assigned a higher rank, or greater weight, than other communication types, such as an instant message. Such higher ranked communications may be viewed as more important, and therefore ranked higher.

A list of recent contacts may be generated for a plurality of users. For example, an organization hierarchy viewer may be accessed by multiple individuals in an organization. A server may generate a list of recent contacts for each individual that initiates communication actions within the organization hierarchy viewer.

A list of recent contacts may be sorted or filtered to create a customized list of recent contacts. As one example, a user may filter the list of recent contacts to show only recent contacts that are located in the same building, that are available for a phone call, or that have been communicated with in the past day. Other filters may be applied to the list of recent contacts. For example, a search filter associated with a specific name may narrow the list of recent contacts to only show recent contacts with that name. Examples of parameters for sorting a list of recent contacts include alphabetical sorting, frequency of communication, date of communication (e.g. most recently communicated recent contacts), by communication type, or distance to recent contact (e.g. closest recent contacts shown above more distant recent contacts).

In an optional step, it may be determined whether the contact associated with the contact identifier of the communication notification is in the directory. A user may be contacted by someone who does not have an entry in the database. For example, a user may receive an email from a new contact, or a phone call from an unknown number. A directory application may determine whether the contact is in the directory, or is a new contact. If it is a new contact, the directory application may prompt the user to add the new contact to the directory and to add further information about the contact.

In one embodiment, a contact may be in a directory, but the contact identifier may not be associated with the contact in the directory. For example, a user may receive a phone call from an unlisted number or a personal email address that is not listed in the directory. The directory application may give the user the option to add the new communication address (e.g. new phone number, new email address) to the existing contact information in the directory.

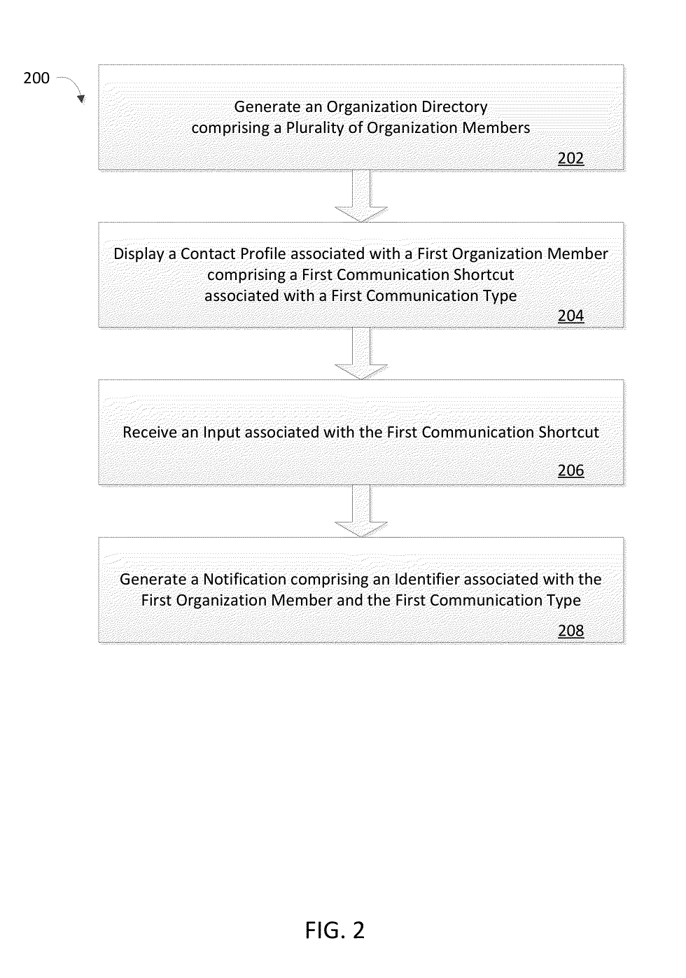

Turning to FIG. 2, FIG. 2 is a flow chart illustrating a second method 200 for generating a list of recent contacts. In the first step 202, an organization directory comprising a plurality of organization members is generated. In one embodiment, an organization hierarchy application generates an enhanced social directory in the form of an organization hierarchy. The organization hierarchy application may display the directory in a graphical user interface. The organization directory may be displayed on a communication device, such as a smart phone (e.g. Android phone, iOS iPhone) or a tablet (e.g. iOS iPad, Android Nexus 7), or on a personal computer.

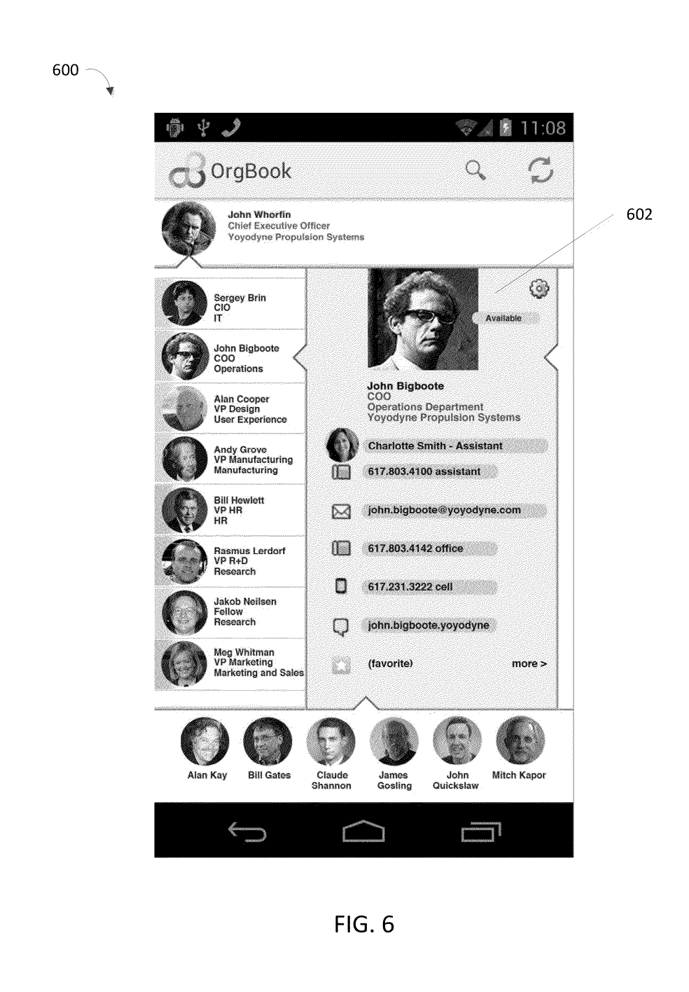

The organization hierarchy application may represent a contact in the directory as a contact profile. One example of an embodiment of a contact profile is illustrated in FIG. 6, discussed below. A contact profile may be generated and displayed for some or all contacts in the directory. In one embodiment, an organization hierarchy application may generate a graphical browser for viewing and navigating the organization hierarchy to see the relationships between different people within an organization.

In second step 204 a contact profile is displayed. The contact profile may be associated with an organization member in the organization directory. A contact profile may comprise information about a contact, such as the contact's name, picture, status, title, department, skills, education, experience, and human resources information.

A contact profile may comprise one or more communication addresses for an organization member. For example, a contact profile may comprise an email address, telephone number, twitter handle, or instant message address. In the embodiment shown in FIG. 6, contact profile 602 comprises a contact picture, a contact status, a contact title, a contact department, an assistant name, an assistant picture, an assistant phone number, a contact email address, a contact cell phone number, a contact office phone number, and a contact instant message address. In other embodiments, a contact profile may include some or all of this information, as well as other contact information.

The organization hierarchy application may generate and display one or more application shortcuts. An application shortcut, sometimes referred to as an application link or application event, may launch an associated application when the application shortcut is selected or activated. A contact profile may comprise one or more application shortcuts, such as communication application shortcuts, or communication shortcuts. Examples of communication shortcuts include an email shortcut for launching an email application, a telephone number shortcut for launching a voice dialer or telephone application, and a text message (e.g. SMS) shortcut for launching a messaging application.

A contact profile may be displayed with a plurality of communication shortcuts to communicate with a contact according to different communication types. For example, a contact profile may comprise an email communication shortcut, an office telephone communication shortcut, and a cellular telephone communication shortcut. When a directory application detects that a communication shortcut has been activated (e.g. selected or clicked), the directory application may cause the associated communication application to launch a communication application as well as open a communication with a particular contact. As an example, activating an application shortcut for an email address may create a draft email to that contact in an email program.

Some application shortcuts may be associated with non-communication applications. For example, other programs associated with an application shortcut may include productivity applications, such as a word processor, presentation maker, spreadsheet program, calendar, project manager, or video editor. Selecting or activating an application shortcut may launch the associated program or application.

In step 206, an input associated with a first communication shortcut may be received. In one embodiment, a user may select, or activate a communication shortcut included in a contact profile. For example, a user may select an email address or telephone number shown in the first contact profile. Such input may signify that the user intends to email, telephone, or otherwise communicate with the contact.

In step 208, a notification is generated. The notification may comprise an identifier associated with a first organization member and the first communication type. A communication identifier may comprise a communication type, such as email, telephone, or text message. The communication identifier may correspond with the communication shortcut selected by a user.

A contact identifier may comprise a contact name or unique number that may be used to identify the person or persons meant to be contacted through a communication shortcut. For example, a user may select an email communication application shortcut within a contact profile of an organization hierarchy viewer. A notification may then be generated comprising a target identifier, the target identifier comprising the contact name.

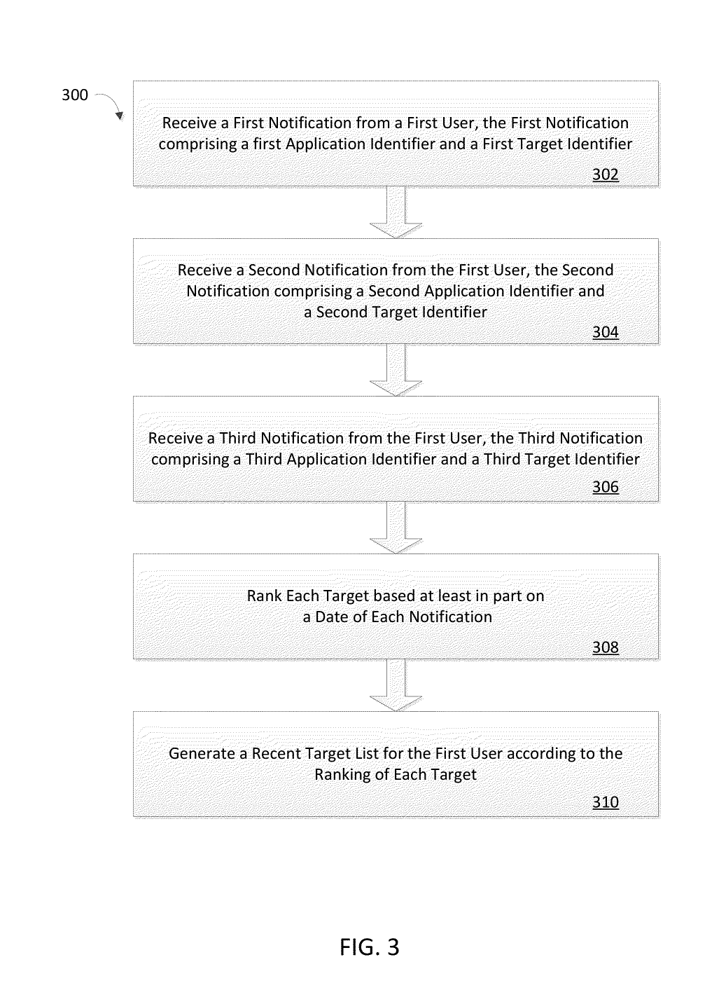

Transitioning to FIG. 3, FIG. 3 is a flow chart illustrating a third method for generating a list of recent contacts. In first step 302, a first notification is received from a first user. The first notification may comprise a first application identifier and a first target identifier.

In second step 304, a second notification is received from the first user. The second notification may comprise a second application identifier and a second target identifier. In third step 306, a third notification is received from the first user. The third notification may comprise a third application identifier and a third target identifier.

An application, such as an organization hierarchy viewer, may generate the notifications. The application may be executing on a communication device, such as a smart phone, tablet, or a personal computer with a network connection. In one embodiment, one or more instances of the same application, such as an organization hierarchy viewer, may exclusively generate the notifications. In another embodiment, various applications may generate notifications.

In one embodiment, a single instance of an application, e.g. an application executing on a first communication device, generates the first notification, the second notification, and the third notification. In another embodiment, multiple instances of an application executing on different devices, each generate one or more notifications. For example, an application executing on a first communication device generates the first notification, while an application executing on a second communication device generates the second notification and the third notification.

A server may be in communication with one or more communication devices, and receive a plurality of over a network, such as an Intranet and/or the internet. An advantage of embodiments of the invention is the ability to track and aggregate a variety of communications across different application logins, over time and across different communication devices.

Each received notification may comprise an application identifier and a target identifier. An application identifier may comprise, for example, an indication of an application launched by a user within another application. In one embodiment an application identifier comprises a communication application identifier, and a target identifier comprises a contact identifier.

In step 308, each target may be ranked based at least in part on a date of each notification associated with that target. For example, a target such as a contact may be ranked based on how recently the contact was communicated with, as reflected by one or more notifications associated with that contact.

In step 310, a recent target list for the first user may be generated. The recent target list may be generated according to the ranking of each target. In one embodiment, a recent target list comprises a list of recent contacts, which displays the most recent contacts that the first user communicated with.

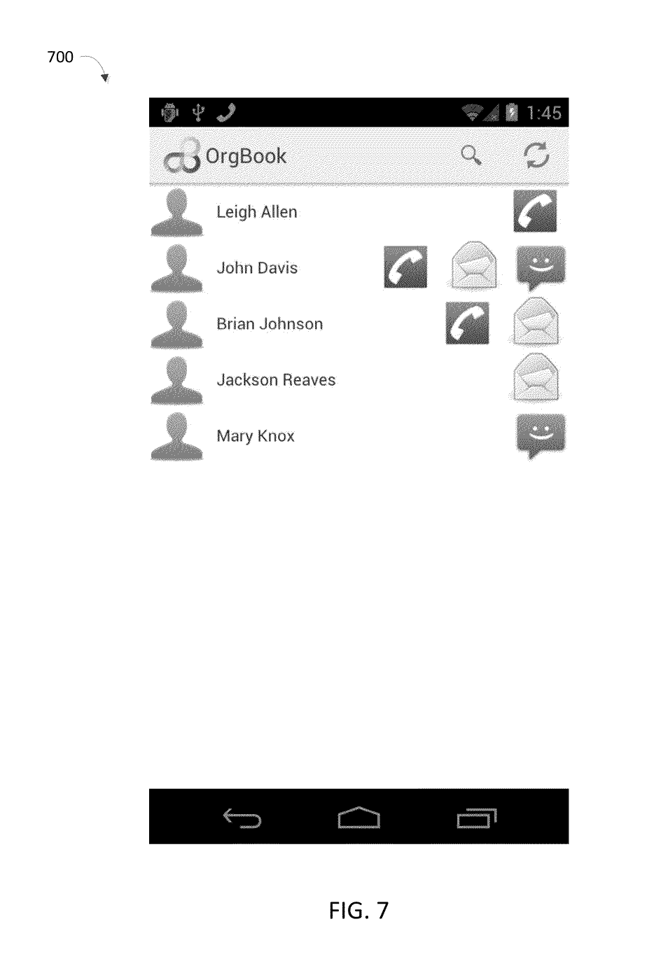

One illustration of an embodiment of a recent contact list is shown in FIG. 7. As shown in FIG. 7, a list of recent contacts may comprise a plurality of contacts. Each entry in the list of recent contacts may include a picture, a name, and one or more icons corresponding to the applications used to communicate with that contact.

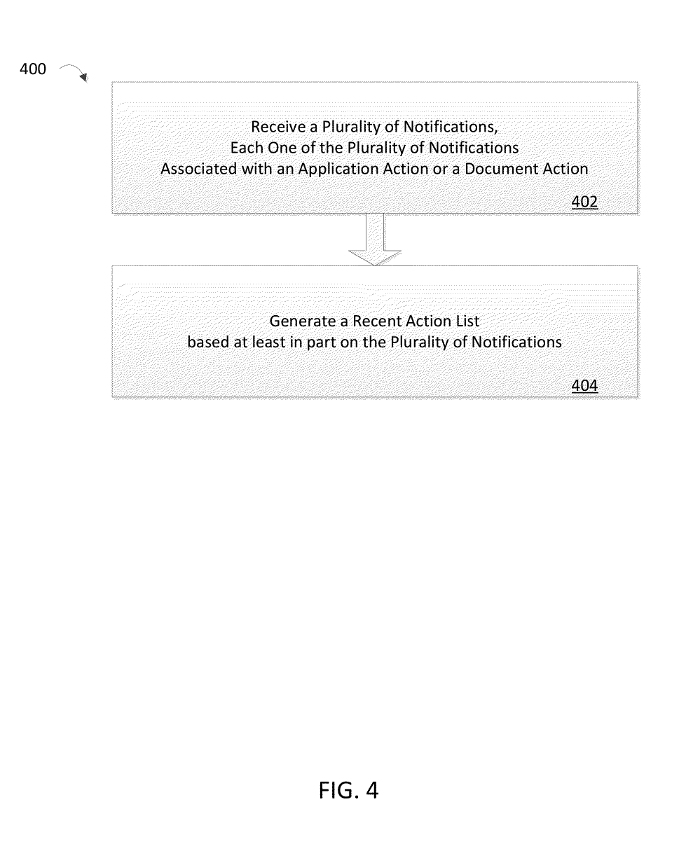

Turning to the fourth drawing, FIG. 4 is a flow chart illustrating an embodiment method 400 for generating a list of recent actions. In the first step 402, a plurality of notifications is received. Each one of the plurality of notifications may be associated with an application action and/or a document action.

In one embodiment, a notification may be associated with an application action. An application action may include a selection or activation of an application shortcut. In one example an organization productivity application, such as a hierarchy viewer, may include application shortcuts to an associated program, such as an email program, a telephone program, and a text message program. Other associated programs may include productivity applications, such as a word processor, presentation maker, spreadsheet program, calendar, project manager, or video editor. Selecting or activating an application shortcut may launch the associated program or application. An organization productivity application may include application shortcuts to productivity applications, such as a word processing application, a spreadsheet application, and/or a calendar application.

In another embodiment, a notification may be associated with a document action. A document action may include a selection or activation of a document shortcut. In one example, an organization productivity application may include document shortcuts to open particular documents, or files, such as word processing files, text documents, presentations, project timelines, videos, and/or spreadsheets. Selecting or activating a document shortcut may launch an application associated with the particular document, and subsequently open that document.

In the second step 404, a recent action list is generated based at least in part on the plurality of notifications. The recent action list may comprise a list of one or more applications recently launched, or used, by a user. In one alternative, the recent action list may comprise a list of one or more documents recently accessed by a user.

In one embodiment, a user accesses a plurality of documents from an organization productivity application. Examples of such documents include text documents, presentations, project timelines, videos, and spreadsheets. When a user accesses a document within the organization productivity application, the application generates a document notification comprising a user identifier and a document identifier.

In the embodiment, a server receives a plurality of document notifications from one or more instances of the organization productivity application. A recent document list may then be generated based on the plurality of document notifications.

### Example Systems

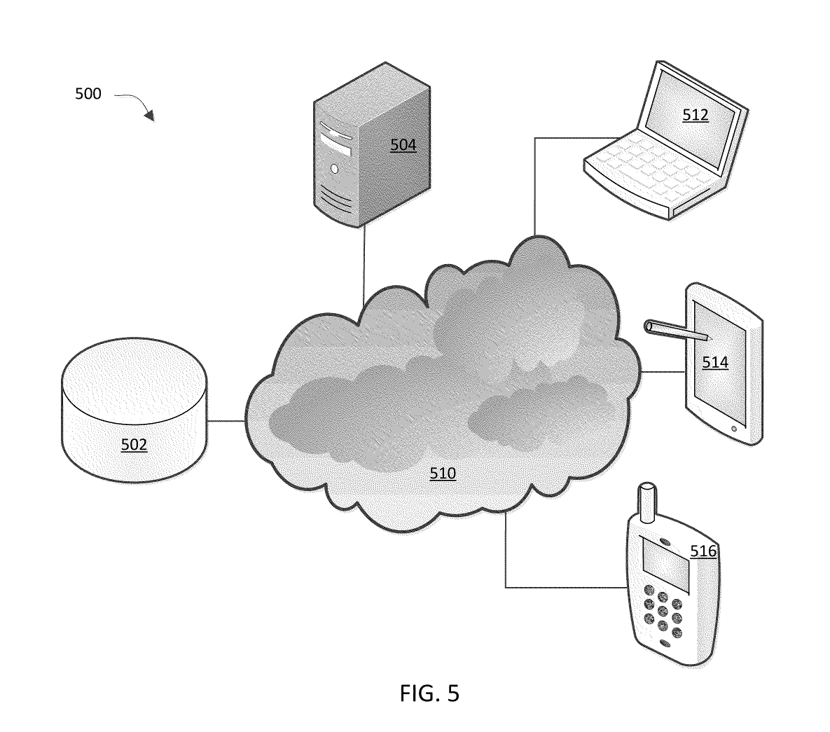

FIG. 5 is a diagram illustrating a system for generating a list of recent contacts. As shown in system 500, communication devices 512, 514, 516 may be in communication with server 504 over network 510. Server 504 and/or communication devices 512, 514, 516 may also be in communication with database 502.

Communication devices include laptop computer 512, tablet 514 and smart phone 516. In other embodiments, other types of communication devices may be used. For example, a computer integrated with a car may be used. Each communication device 512, 514, 516 may be configured to communicate in one or more types of communication. For example, tablet 514 may be used to video chat, email, and text message. Smart phone 516 may be used to email, text message, and place telephone calls. Laptop computer 512 may be used to video chat, email, and instant message. Additionally, communication devices 512, 514, 516 may be configured to utilize other types of communication such as social networking (e.g. LinkedIn, Twitter) and online forums.

An application, such as an organization hierarchy viewer, may be presented within a graphical user interface executing on one or more communication device 512, 514, 516. The application may comprise a native mobile device application such as an iOS iPad application, a Windows Mobile application, or an Android application. As one alternative, the application may comprise a web application accessed through a web browser.

Each instance of an application may be associated with a current user. For example, the application may utilize a login procedure, wherein a user enters login credentials to access the application.

The application may display one or more contact profiles, such as the one shown in FIG. 6. In other embodiments, other contact profiles may be displayed. A contact profile may be associated with a contact, such as a member of an organization, a potential client, or a supplier. In one embodiment, an organization hierarchy viewer may display information received from an organization directory, such as an Active Directory database.

A contact profile may comprise a contact identifier. A contact identifier may comprise a contact name, a user id, or an employee number. In one embodiment, a contact identifier may be a unique identifier tied to one person in an organization. For example, a contact identifier may be stored in an Active Directory database, and incorporated into a contact profile shown in an organization hierarchy application.

A contact profile may comprise one or more communication shortcuts. A communication shortcut may be associated with a type of communication, and launch a communication application related to that communication type. Examples of communication types include email, telephone (i.e. voice phone), text message, instant message, and video chat (i.e. video phone). A communication shortcut, such as an email shortcut, may provide a link to an email application. Similarly a telephone shortcut may provide a link to a voice phone application.

In one embodiment, a user views an organization hierarchy application within a graphical user interface on an iOS iPhone. Using the organization hierarchy application, the user navigates an organization hierarchy to select a contact profile to view. The contact profile includes that contact's name, picture, email address, and telephone number. By selecting the contact's email address, the application launches an email program. Additionally, the application generates a contact notification comprising the contact's name and the type of communication selected, i.e. email. The contact notification is transmitted to a server, which may be configured to receive a plurality of contact notifications.

Upon receiving a contact notification, the server may update or generate a list of recent contacts. The list of recent contacts may include a list of contacts that were recently contacted. In the example, the list is arranged in descending order, in which the contact associated with the most number of notifications, i.e. the most contacted contact, is at the top of the list, and the contact associated with the least number of notifications, i.e. the least contacted contact, is at the bottom of the list. The list of recent contacts may also include the types of communication used to communicate with each contact on the list of recent contacts. In the example, an icon representing each type of communication (e.g. a phone icon, email icon, video chat icon, etc.) is shown alongside the contact name.

### Screenshots

FIG. 6 is a screenshot 600 illustrating a first view of an embodiment for generating a list of recent contacts. As shown in screenshot 600, an Android application, such as an organization hierarchy viewer, is displayed in a graphical user interface. In other embodiments, the application may comprise an iOS iPhone application, an iOS iPad application, or a web application. Embodiments of an organization hierarchy viewer are further described in related U.S. Provisional Application No. 61/656,322, file 6 Jun. 2012 and entitled “METHODS AND SYSTEMS FOR INTEGRATED SOCIAL MEDIA, STRATEGY, AND ORGANIZATIONAL HIERARCHY.”

As shown in FIG. 6, the organization hierarchy viewer comprises a plurality of contact profiles. In one embodiment, an organization hierarchy viewer may display contact profiles in an expanded or a collapsed view. In a collapsed view, a contact profile may only show a contact's picture and name. In one alternative, a contact profile may show a contact's picture, name, and title. In other alternatives, a collapsed view may show different information about a contact. The organization hierarchy viewer may also display one or more contact profiles in an expanded view.

Organization hierarchy viewer application displays active contact profile 602 comprising one or more communication shortcuts. In the figure, contact profile 602 is illustrated in an expanded view, and shows more information than other contact profiles illustrated in collapsed views. Contact profile 602 includes a picture, status, name, title, department, and organization of the associated contact. In other embodiments, a contact profile may depict some or all of this information and/or other information.

FIG. 7 is a screenshot 700 illustrating a second view of an embodiment for generating a list of recent contacts. As shown in screenshot 700, an organization hierarchy viewer displays a list of recent contacts in a graphical user interface. In one embodiment, the list of recent contacts list is based on a plurality of notifications generated by an organization hierarchy viewer application and received by a server. The list may be compiled by the server, and transmitted back to the application.

As shown in FIG. 7, the list of recent contacts comprises five recent contacts. In other embodiments, a list of recent contacts may include zero, one, or more contacts displayed on the same screen or over a plurality of screens (e.g. displayed by scrolling or page turning). One or more types of information may be shown with each recent contact. For example, in FIG. 7, each listing includes a contact picture, a contact name, and one or more communication icons. The icons may represent the various types of communication used to communicate with each recent contact.

An initial list of recent contacts for a user may be initialized with zero contacts, or shown as being empty. For example, when a user initially joins an organization and logs into the application for the first time, the list of recent contacts may be empty, signifying that the user has not communicated with any contacts. As a user initiates communication with one or more contacts, and/or successfully communicates with one or more contacts, the list of recent contacts may be updated with each recent contact.

The list of recent contacts may also be updated as a recent contact is communicated with in a different manner. For example, as shown in FIG. 7, the first most recent contact is shown with one communication icon, a telephone icon. In the example, a user may later email the first most recent contact. Upon initiating the email, a notification may be generated by the organization hierarchy including the email communication type along with the first most recent contact name. The server may then update the list of recent contacts to reflect the new communication type. Based on the updated list, the view of the list of recent contacts may then be updated within the organization hierarchy viewer application.

As shown in FIG. 7, the list of recent contacts comprises a plurality of contacts and a plurality of communication type icons. In other embodiments, other information may be depicted in List of recent contacts. For example, List of recent contacts may include the date and/or time that a listing was most recently contacted. As another example, List of recent contacts may show the status of each recent contact and/or an indication of whether a recent contact is available, in a meeting, or away.

In one embodiment, the list of recent contacts may be filtered by default according to most recent communication (i.e. the most recently communicated contact is the first item on the list of recent contacts). Other filtering criteria may be used for a default view.

The list of recent contacts may ordered according to one or more criteria. Such criteria may include, but is not limited to, location, status, name, communication type, group, team, department, or organization. For example, a list of recent contacts may be filtered to show recent contacts that belong to a development team and are located on the same floor as a user. As another example, a list of recent contacts may be sorted according to availability across various communication types. Recent contacts that are available for telephone calls and instant messages may appear higher in the list than recent contacts that are only available through email.

In one example, a list of recent contacts is filtered by a search term, such as a particular city, or by a first name. As another example, a recent contacts list may be alphabetically sorted.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium s on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

1. A method for listing recent contacts across different types of communications, the method comprising:
generating a directory comprising a plurality of contacts;
receiving a communication notification comprising a communication type and a contact identifier associated with one of the plurality of contacts;
updating a list of recent contact based on the contact and the communication type.

2. The method of claim 1, further comprising:
determining whether the contact is in the directory.

3. A method for generating a list of recent contacts, the method comprising:
generating an organization directory comprising a plurality of organization members;
displaying a plurality of communication shortcuts associated with a first organization member of the plurality of organization members;
receiving a communication request associated with a first one of the plurality of communication shortcuts;
updating a list of recent contacts based at least in part on the communication request, the list of recent contacts comprising at least one of the plurality of organization members.

4. The method of claim 3, wherein each one of the plurality of communication shortcuts is associated with a communication type, and wherein the communication type comprises one of email, telephone, text message, video chat, or instant message.

5. The method of claim 3, wherein a first one of the plurality of communication shortcuts is associated with a first type of communication and a second one of the plurality of communication shortcuts is associated with a second type of communication different from the first type of communication.

6. The method of claim 3, further comprising
displaying a profile in a graphical user interface of the first organization member comprising the plurality of communication shortcuts.

7. The method of claim 3, wherein each one of the communication shortcuts causes a communication application to be launched.

8. The method of claim 7, wherein the communication application comprises one of an email application, a telephone application, a text message application, a video chat application, or an instant message application.

9. The method of claim 3, wherein generating an organization directory comprises generating an organization hierarchy, and the organization hierarchy comprises the plurality of organization members.

10. The method of claim 3, further comprising:
determining a ranking of recent contacts based at least in part on the first notification and the second notification.

11. The method of claim 10, further comprising:
assigning a first weight to the first communication type;
assigning a second weight to the second communication type, and wherein the ranking is based at least in part on the first weight and the second weight.

12. A method for generating a list of recent contacts, the method comprising:
generating an organization hierarchy comprising a plurality of organization members;
displaying a first contact profile associated with a first one of the plurality of organization members, the first contact profile comprising a first communication shortcut associated with a first type of communication and a second communication shortcut associated with a second type of communication, the first type of communication shortcut different from the second type of communication shortcut;
receiving a communication input associated with the first communication shortcut comprising an identifier associated with the first organization member and the first type of communication;
assigning a weight to the communication based at least in part on the type of communication;
updating a list of recent contacts based at least in part on the communication input and the assigned weight.
